(19) United States
(12) Patent Application Publication
(10) Pub. No.: US 2026/0170409 A1
(43) Pub. Date: Jun. 18, 2026

(54) MACHINE LEARNING PATTERNS OF FAILURE IN BROADBAND NETWORKS

(71) Applicant: British Telecommunications Public Limited Company, London Greater London (GB)

(72) Inventors: Moustafa Ashraf Fawzy Moustafa MAHMOUD, London (GB); Gideon ACQUAAH-HARRISON, London (GB); Mithu JAMES, London (GB); Robert ANTONIO, London (GB)

(21) Appl. No.: 19/121,369

(22) PCT Filed: Sep. 25, 2023
(86) PCT No.: PCT/EP2023/076392

§ 371 Date: Apr. 15, 2025

(30) Foreign Application Priority Data
Oct. 28, 2022 (EP) 22204566.8

(51) Int. Cl. G06N 20/00; G06F 11/07

(52) U.S. Cl. CPC G06N 20/00; G06F 11/0709

(57) ABSTRACT

A method of diagnosing a potential fault on a broadband connection line is provided. The method comprises receiving line data associated with a plurality of connection lines, analysing, by a machine learning algorithm, the line data, and classifying, by the machine learning algorithm, the plurality of connection lines into a plurality of clusters based on the analysing of the line data. Here, each of the plurality of clusters comprises a subset of the plurality of connection lines. The method further comprises assigning, by the machine learning algorithm, a label to each cluster of the plurality of clusters, each label indicating the overall connection line performance of the connection lines in that cluster, and generating a metric score for each of a plurality of metrics associated with the performance of that connection line. For each of the plurality of connection lines, deviating metric scores are identified from among the generated metric scores for that connection line, wherein a deviating metric score is a metric score indicates a potential fault on that connection line. For each identified deviating metric score, a recommendation is generated based on one or more of: the label of the cluster to which the connection line associated with that deviating metric score has been assigned, the type of metric associated with that deviating metric score, or the magnitude of the deviating metric score. The generated recommendation is then outputted for each connection line identified as having a deviating metric score.

### TECHNICAL FIELD

Embodiments described herein relate generally to methods of diagnosing faults in a broadband network using machine learning algorithms.

### BACKGROUND

The correct functioning of broadband internet networks relies upon multiple different parameters and systems, such as the infrastructure network, FTTP (fibre to the property), and Home networks. As such, there may be multiple causes of any fault or loss of service on a broadband line, which can be difficult and time consuming to diagnose. Furthermore, visits by an engineer to a property or site to rectify any faults may not be unsuccessful or unnecessary, such as where the cause of a fault is in a different location, or where the nature of the fault is such that it cannot be rectified by an engineer visit. Fast and accurate diagnoses of faults in broadband lines is therefore desirable, so that such faults can be rectified quickly and without any unnecessary engineer visits.

### SUMMARY OF INVENTION

The present application relates to the field of diagnostics in broadband connection lines.

In particular, the present application provides methods and systems employing machine learning algorithms to identify patterns of failure in broadband connection lines. This allows for more accurate diagnostics to be made at the point a potential fault is reported, identifying the cause of any potential issues and reducing instances of unnecessary engineer callouts. The present methods and systems also provide plain English explanations of the diagnostic results and resulting recommendations, so that engineers that are called out may be better informed of the potential problem and customers may be better informed when reporting an issue.

In accordance with a first aspect of the invention, there is provided a method of diagnosing a potential fault on a broadband connection line, the method comprising: receiving line data associated with a plurality of connection lines; analysing, by a machine learning algorithm, the line data; classifying, by the machine learning algorithm, the plurality of connection lines into a plurality of clusters based on the analysing of the line data; wherein each of the plurality of clusters comprises a subset of the plurality of connection lines; assigning, by the machine learning algorithm, a label to each cluster of the plurality of clusters, each label indicating the overall connection line performance of the connection lines in that cluster; generating a metric score for each of a plurality of metrics associated with the performance of that connection line; identifying, for each of the plurality of connection lines, deviating metric scores from among the generated metric scores for that connection line; wherein a deviating metric score is a metric score indicates a potential fault on that connection line; generating, for each identified deviating metric score, a recommendation based on one or more of: the label of the cluster to which the connection line associated with that deviating metric score has been assigned; the type of metric associated with that deviating metric score; or the magnitude of the deviating metric score; and outputting the generated recommendation for each connection line identified as having a deviating metric score.

The present invention therefore provides a method of monitoring and diagnosing potential faults on a broadband connection line more quickly and more accurately than conventional methods. Furthermore, the present invention allows for a better judgement of whether such a potential fault may be remedied by an on-site engineer visit, thereby reducing instances of unnecessary engineer visits.

Any of the following may be applied to the above first aspect of the invention.

The identifying of the deviating metric scores and the generating of the recommendation may be carried out by a hypothesis testing algorithm.

The classifying by the machine learning algorithm may include employing a Gaussian mixture model.

The recommendation for each connection line identified as having a deviating metric score may include a recommendation regarding whether an engineer should be dispatched to investigate the connection line.

The recommendation for each connection line identified as having a deviating metric score may include a recommendation indicating the type of potential fault on that connection line.

The recommendation for each connection line identified as having a deviating metric score may include a recommendation indicating whether the potential fault on that connection line is located in one or more of: the home network of the connection line; the fibre to the property, FTTP, of the connection line; or the network infrastructure of the connection line.

The recommendation for each connection line identified as having a deviating metric score may include a recommendation indicating a potential remedy of the potential fault on that connection line.

The method may further comprise: generating, by the machine learning algorithm, a plain English explanation for each generated recommendation; and outputting the plain English explanation with the generated recommendation for each connection line identified as having a deviating metric score.

The method may be implemented as a batch-processing method.

The method may further comprise one or more of: storing the received line data in a database; and storing the generated recommendation for each connection line identified as having a deviating metric score in the database.

The method may further comprise: prior to classifying the plurality of connection lines into a plurality of clusters processing the line data, processing the line data such that the line data for each connection line is in the same format.

In accordance with a second aspect of the invention, there is provided a system comprising: one or more processors; a non-transitory memory; and one or more programs, wherein the one or more programs are stored in the non-transitory memory and configured to be executed by the one or more processors, the one or more programs including instructions for performing any of the methods of the first aspect of the invention discussed above.

In accordance with a third aspect of the invention, there is provided a non-transitory computer readable storage medium storing one or more programs, the one or more programs comprising instructions, which, when executed by an electronic device with one or more processors, cause the electronic device to perform any of the methods of the first aspect of the invention discussed above.

In the following, embodiments will be described with reference to the drawings in which:

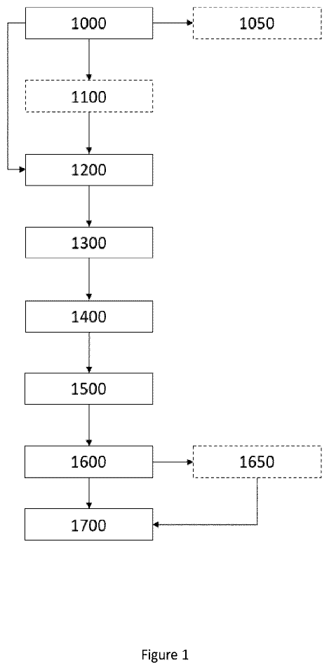

FIG. 1 shows a flow chart of the method of connection line fault diagnosis according to some embodiments.

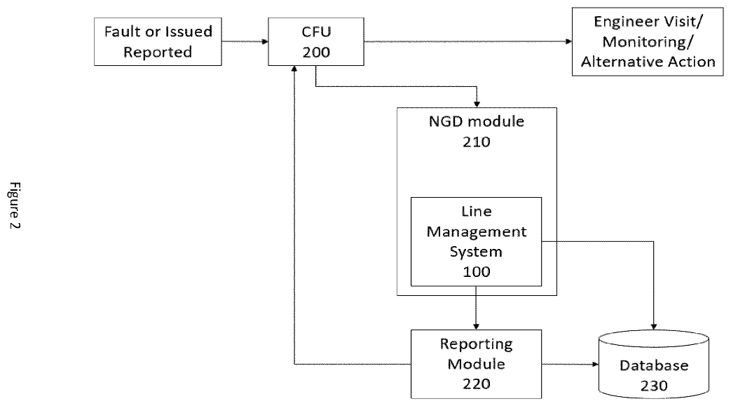

FIG. 2 shows a system employing modules that carry out the method of connection line fault diagnosis according to some embodiments.

### DETAILED DESCRIPTION

The present application broadly relates to broadband fault diagnoses and troubleshooting. When a customer experiences issues with their internet connectivity this could be due to numerous factors such as usage, bandwidth, the amount of Wi-Fi devices connected etc. Since there are multiple reasons as to why a customer may experience intermittent connections or a drop in connection speed, a series of tests must be run on the associated connection line to contribute to a diagnosis of any potential problem.

Existing approaches to troubleshooting a broadband connection line include carrying out tests based on real-time data. These tests conventionally use heuristic approaches which are based on business rules. If a historically bad line has relatively good metrics at the time of testing, it returns a “No-Fault” code. However, if there is an underlying issue, this would be expected to reoccur later.

Furthermore, in such existing systems, a platform called a next generation diagnostics (NGD) module is often used to run the diagnostic tests. Therefore, the NGD module may be broadly understood as a diagnostic module.

Here, to diagnose faults on a connection line, the NGD usually runs tests in three modules: Home (i.e. Home networks), FTTP (i.e. Fibre To The Property), and Networks (i.e. the overall infrastructure which the broadband connection uses). The tests on each module are made up of a series of sub-tests, for example an “xDSL Copper test” (which is an intrusive test of the copper circuits in the network). Here, over fifteen sub-tests which can potentially be run, each with their own algorithms and routines. As a result, the sub-tests for the Home modules will be different from the sub-tests for the Network module. Upon determining which tests passed or failed the fault case is marked with a diagnostic result, indicating for instance that a problem was in the Network, or in the Home, or that all the tests run indicated no issues with the connection line.

This conventional approach is therefore complicated, costly, time-intensive, and may not consistently indicate a fault where a fault is actually present (e.g. if that fault is not occurring at the time the test is run). In addition, this conventional approach often does not produce a detailed explanation of the cause of a potential fault (often only an indication that a fault may exist).

By comparison, the approach of the present application allows connection lines to be classified into groups or clusters, so that those that have been historically underperforming are identified as such, along with insights with respect to where the connection line might be failing.

This “patterns of failure” approach of the present application may then be integrated into existing diagnostic frameworks, and provides the advantages of being simpler, saving time, reducing costs, improving accuracy and consistency, as well as providing a detailed explanation of the potential cause of a connection line fault. This approach also provides a clear recommendation with regard to the assignment of engineers to further reinvestigate or remedy a fault, therefore reducing the number of unnecessary engineer visits to sites and allowing engineers to gain an insight into a fault before arriving on the site (therefore saving time).

FIG. 1 shows a method of connection line fault diagnosis according to the present application.

Here, a line management system 100 collects line data 120 from a customer's broadband connection line 150. This line data 120 may include data relating to a series of metrics associated with the quality and performance of the customer's broadband connection. The line management system 100 collects line data 120 associated with a plurality of connection lines 150, where each set of line data 120 relates to a connection line 150 of that plurality of connection lines 150.

In some embodiments, the line data 120 for each connection line 150 may include data relating to at least one of the following metrics:
Current download speed
Minimum, maximum, and average download speeds over a first period of time (e.g. over the previous 3 days)
Minimum, maximum, and average download speed over a second period of time (e.g. over the previous 7 days)
Minimum, maximum, and average download speed over a third period of time (e.g. over the previous 14 days)
The number of session drops (where the line 150 is out of sync with the network) over a period of time (e.g. over the last 3 days)
The number of initialisations (or retrains), where the router for the line 150 restarts automatically to correct a detected error, over a period of time (e.g. over the last 3 days)
The mean time between each type of error (e.g. session drops, initialisations, etc) over a period of time (e.g. over the last 3 days)
The number of errors recorded on the connection line 150 over a period of time (e.g. over the course of a day)
The amount of outage time experienced on the connection 150 over a given period of time (e.g. over every hour of a day)
Minimum, maximum and average flow of packets (usage) recorded for the line 150 (e.g. over the previous 3 days)
Minimum, maximum and average flow of packets (usage) recorded for the line 150 (e.g. over the previous 7 days)
Minimum, maximum and average flow of packets (usage) recorded for the line 150 (e.g. over the previous 14 days)

It will be understood that the above list of metrics is non-limiting, and that data related to other suitable line metrics may be included in the line data 120.

In some embodiments, the line data 120 may be collected on-demand, for instance when a customer reports a line fault, or when the line management system 100 isolates a particular connection line 150 for analysis.

In some embodiments, the line data 120 may be collected periodically for a plurality of connection lines 150. This may be referred to as “batch-processing”. For example, line data 150 may be updated with new line data 150 for a chosen plurality of connection lines 150 every 7 days.

This batch processing approach allows the line management system 100 to carry out the following method in advance of any issue being reported on a connection line 150, so that when issues are reported, the line management system 100 is able to respond more quickly in providing recommendations regarding a course of action.

The line management system 100 may store the collected line data 120 in a database.

In some embodiments, the line data 120 may then be processed to form a set of processed line data 125 for each connection line 150 of the plurality of connection lines 150. This processing may include normalisation to ensure that the processed line data 125 for each line 150 is in the same format as the processed line data 125 for each of the other lines 150.

The plurality of connection lines 150 is then analysed by a machine learning algorithm 160 of the line management system 100 based on the line data 120 (or, where the line data 120 has been processed into a set of processed line data 125, based on the processed line data 125) for each of the plurality of connection lines 150.

Here, the machine learning algorithm 160 determines a plurality of clusters, where each cluster comprises a subset of the plurality of connection lines 150 with similar attributes or metrics based on the line data 120 for each of those connection lines 150.

For example, the line data 120 for each line connection 150 in a group of line connections 150 may have certain metrics that are considered by the machine learning algorithm to be similar (for example, similar values for the average download speed over the preceding 14 days). As a result, the machine learning algorithm 160 may determine that those line connections 150 with similar metrics in their line data 120 should be grouped together to form a cluster.

When sorting the plurality of connection lines 150 into clusters, the machine learning algorithm 160 may determine a suitable number of clusters based on the line data 120 for each of the plurality of connection lines 150 using a suitable method.

In some embodiments, the machine learning algorithm 160 may employ a Gaussian Mixture model or a K-means clustering model to cluster the connection lines 150.

In some embodiments, the machine learning algorithm 160 may calculate a silhouette score to assess the suitability of the clusters that are found. A silhouette score is a measure of how cohesive a group of clusters are, relative to the distance between the clusters. The elbow method of the silhouette score determines where the algorithm has found the optimal amount of clusters.

In some embodiments, the machine learning algorithm 160 may calculate a “gap statistic” to assess the suitability of the clusters that are found. A gap statistic is a method to compare the clusters that are found to clusters on uniformly random data, and is therefore a relatively principled way of finding the optimal number of clusters. Here, the number of clusters that achieves the maximum gap statistic indicates that the algorithm has found genuinely distinct clusters.

For each cluster that has been found, a label may then be assigned to that cluster indicating the overall line performance of the connection lines 150 in that cluster. For example, some clusters may be assigned the label “Good lines” (i.e. lines with a good performance), some clusters may be assigned the label “Bad Lines” (i.e. lines with poorer performance), and some clusters may be assigned the label “Unsure Lines” (i.e. where the overall performance of the lines 150 in a cluster cannot be deemed either good or poor performance). As a further example, some clusters may be assigned the label “Good lines” based on the lines 150 of that cluster experiencing 100% of the expected download speed, some clusters may be assigned the label “Intermediate Lines” based on the lines 150 of that cluster experiencing 70% of the expected download speed, and some clusters may be assigned the label “Bad Lines” based on the lines 150 of that cluster experiencing 50% of the expected download speed (i.e. high performing, mid performing, low performing).

In some embodiments, the assigning of labels to each cluster may be done manually by a human engineer or service specialist (i.e. based on the line data 120 and the lines metric associated with that line data 120).

In some embodiments, the assigning of labels to each cluster may be done by the machine learning algorithm 160 itself, where the machine learning algorithm 160 has previously been trained on earlier data to be able to assess whether the attributes of the lines 150 in a cluster indicate “Good”, “Bad”, or “Unsure” levels of performance.

The definition of a cluster as including “Good”, “Bad”, or “Unsure” connection lines 150 may include assessing whether the attributes are above or below certain predetermined thresholds.

The machine learning algorithm 160 then carries out an analysis of the metrics for each connection line 150 in each cluster.

Here, for each metric of each line 150 in a cluster, the machine learning algorithm 160 analyses that metric for that line 150 and calculates a score 165.

In some embodiments, each score 165 for a metric may be calculated by comparing the value for that metric for that line compared with the value for the equivalent metrics for the other lines 150 in a cluster.

In some embodiments, the scores 165 for each metric for each line 150 may be calculated by comparing the value for that connection line's 150 metric with a value for that metric associated with the cluster labelled as having the most optimum performance (e.g. the “Good” cluster). For example, the value for a given metric for a given line 150 may be compared with an average value for that metric for the lines 150 in that cluster labelled as having the most optimum performance (e.g. the “Good” cluster), from which a score 165 for that metric can be calculated.

In some embodiments, the scores 165 for each metric for each line 150 may be calculated by comparing the value for that line's 150 metric with a value for that metric at the centre of the cluster labelled as having the most optimum performance (e.g. the centre of the “Good” cluster). Here, the “centre” of a cluster may be determined using the centroid for the metric in question (e.g. when plotted for the metric in question), where the clusters identified have their centroids learned by the machine learning algorithm 160

It is highlighted that a connection line 150 may be placed into a lower ranking cluster (e.g. a cluster labelled as having a “Bad” level of performance) because one, or more, of the metric(s) deviates from other metrics of other lines 150 in higher ranking clusters to a particularly high degree. However, the deviation of that metric could for example be part of a general network incident. Consequently, by assessing the scores for each metric relative to a cluster with a “Good” label, this reduces the likelihood of such a misassigned of a line 150 into a lower ranking cluster.

The machine learning algorithm 160 then assesses the calculated scores 165 for each metric for each connection line 150 to identify any scores 165 for metrics that are above a predetermined threshold for that metric. Those scores 165 that are identified as being above a certain threshold are flagged as deviating metric scores 170 that are a potential problem metric for the line 150 in question.

The machine learning algorithm 160 then passes the identified deviating metric scores 170 to a hypothesis testing algorithm 163 which then assesses the deviating metric scores 170 for each line 150 and generates a recommendation for each line 150 with regard to whether a visit by an engineer would be warranted to investigate the deviating metric. For example, the hypothesis testing algorithm 163 may assign a recommendation of one of “Visit”, “No Visit”, or “Monitor” for each of the deviating metric scores 170 for each connection line 150.

In some embodiments, the hypothesis testing algorithm 163 may calculate the scores 165 for each metric for each connection line 150 and identify the deviating metric scores 170 (e.g. that functionality of the machine learning algorithm 160 may be carried out by the hypothesis testing algorithm 163.

Here, a “Visit” recommendation would indicate that an engineer should be sent out to investigate whether there is a potential fault on a line that could be remedied by an engineer. Similarly, a “No Visit” recommendation would indicate that an engineer should not be sent out to investigate whether there is a potential fault on a line, since the deviation may not be indicative of a potential fault, or since a visit by an engineer would be unlikely to remedy a fault. A “Monitor” recommendation would indicate that, whilst no engineer should be sent out to investigate whether there is a potential fault on a line, that line 150 should nonetheless be monitored for a period of time to assess whether a fault could potentially develop.

The recommendation derived by the hypothesis testing algorithm 163 may be based upon one or more of the label of the cluster of the line 150 in question, the specific metric of the line 150 that is determined as having a deviation, or the size of the deviation of that metric.

In some embodiments, the recommendation may be derived based on a prioritisation of different metrics for the line 150. For example, if a metric considered to have a low priority is experiencing a small sized deviation, hypothesis testing algorithm 163 may recommend that “No Visit” by an engineer is necessary. As a further example, if a metric considered to have a high priority is experiencing an intermediate or larger sized deviation, the hypothesis testing algorithm 163 may recommend that a “Visit” by an engineer is necessary. As a further example, if a metric considered to have a high priority is experiencing a small sized deviation, the hypothesis testing algorithm 163 may recommend that a no visit by an engineer is necessary, but that the line 150 in question should be monitored (i.e. the “Monitor” recommendation).

In cases where the recommendation is that a “Visit” by an engineer is necessary, it may be concluded that the problem is indicative of a fault that significantly affects the performance of the line 150, and that an engineer would be likely to diagnose and remedy that fault.

In cases where the recommendation is that “No Visit” by an engineer is necessary, it may be concluded that the problem is at a network level (e.g. the fundamental infrastructure of the network) and therefore an engineer would not be able to address the problem. Similarly, it may be concluded that the problem is associated with the address of the line owner (i.e. the line owner's router is faulty or the wiring within the line owner's residence is faulty), and therefore an engineer would not be able to address the problem.

In cases where the recommendation is that the line 150 in question should be monitored (i.e. “Monitor”), it may be concluded that the problem is potentially indicative of a fault, but that fault is minor or does not significantly affect the performance of the line 150. As such, the line 150 can be monitored in case the potential fault worsens and a later assessment concludes that an engineer would be likely to diagnose and remedy that fault.

In some embodiments, the line management system 100 may additionally generate an output including the recommendations for each connection line 150.

The output may take the form of an output to a database, where the recommendations for each connection line 150 may be stored.

In addition, or as an alternative, the output may take the form of a report to a system administrator including the recommendation for each connection line 150.

In some embodiments, the output may also include an explanation of the reason for the recommendation. Here, the explanation of the reason for the recommendation may be generated in plain English. This allows the output to potentially be provided to engineers, customer support staff or agents (i.e. as part of a report), as well as to customers to advise why the recommendation has been made in a clear and easily understood manner.

Where the recommendations for each connection line 150 are output to a database for storage, the line management system 100 may also output the explanation in plain English of the reason for the recommendation. This allows the recommendation and the plain English explanation to be accessed at a later date by engineers or customer support staff or agents, if for instance the owner of a connection line 150 later reports a fault associated with the line 150.

It is highlighted that the above functionality of the machine learning algorithm 160 may be implemented by a single machine learning algorithm, or may be implemented by several machine learning algorithms operating together. For example, one machine learning algorithm may be trained to identify clusters of connection lines 150 based upon the values of the metrics for those lines, whilst another machine learning algorithm (or, in some embodiments, the hypothesis testing algorithm 163) may be trained to identify the deviating metric scores 170 for each line 150 and generate a recommendation for each line 150 with a deviating metric score 170 (i.e. identify the patterns of failure associated with deviation from that line metric).

To achieve the above discussed functionality, the machine learning algorithm 160 may be continuously trained and updated based on the periodic collection of line data 120 and the verification of the accuracy of the recommendations generated by the machine learning algorithm. For example, the machine learning algorithm 160 may be updated and retrained by assessing whether the generated recommendations are subsequently found to be accurate (e.g. that an engineer visit was warranted, or that a fault was found that was associated with the metric having the deviating metric score 170 for the line 150 in question).

The machine learning algorithm 160 may also be trained using the results of other diagnostic tests. For instance, by using the results of other diagnostic tests, compared with the subsequent outcome of engineer visits, the machine learning algorithm may be trained to recognise which deviating metric scores 170 are most likely to require an engineer visit, or which deviating metric scores 170 are most likely to result in a significant fault on a connection line.

Returning to FIG. 1, the process and functionality discussed above may be applied to the steps of the flowchart shown in that figure.

Some of the steps shown in FIG. 1 are optional steps (that is to say, not essential to work the invention of the present application). Such optional steps are indicated as such with a dotted line.

At Step 1000, the line management system 100 collects line data 120 associated with a plurality of connection lines 150. Here, the line data 120 includes data relating to a series of metrics for each connection line 150, each metric being associated with the performance of the connection line 150 in question.

In some embodiments, Step 1000 may proceed to Step 1050. If Step 1050 is not included, the process proceeds directly to Step 1100.

At Step 1050, the line management system 100 may store the line data 120 in a database.

At Step 1100, the line data 120 may be processed to form a set of processed line data 125 for each connection line 150 of the plurality of connection lines 150.

At Step 1200, a machine learning algorithm 160 of the line management system 100 analyses the line data 120 (or processed line data 125) in order to determine a plurality of clusters of connection lines 150. Here, each cluster comprises a subset of the plurality of connection lines 150, each with similar values of metrics based on the line data 120 for each of those connection lines 150.

The machine learning algorithm 160 may be a Gaussian Mixture model or a K-means clustering model to cluster the connection lines 150.

At Step 1300, a label is assigned to each cluster indicating the overall line performance of the connection lines 150 in that cluster. This may be based upon the common or similar values of the metrics of the connection lines 150 in that cluster.

In some embodiments, the assigning of a label to each cluster may be done by a human engineer, or may be done by the machine learning algorithm 160.

At Step 1400, the machine learning algorithm 160 analyses each metric for each connection line 150 in each cluster, and calculates a score 165 for each metric for each connection line 150.

At Step 1500, the machine learning algorithm 160 assesses the scores 165 to identify deviating metric scores 170. Here, the score 165 for each metric for each connection line 150 is assessed to identify any scores 165 are above a predetermined threshold for that metric. Those scores 165 that are identified as being above a certain threshold are flagged as deviating metric scores 170 that are a potential problem metric for the line 150 in question.

At Step 1600, the machine learning algorithm 160 generates a recommendation for each deviating metric scores 170 for each connection line 150. Here, the recommendation relates to whether a visit by an engineer would be warranted to investigate the deviating metric. Each recommendation may be based upon one or more of the label of the cluster of the line 150 in question, the specific metric of the line 150 in question, or the size of the deviation of that metric.

At Step 1650, the machine learning algorithm 160 may generate explanation of the reason for each recommendation for each connection line 150 identified as having a deviating metric scores 170. Here, each explanation of the reason for the corresponding recommendation may be generated in plain English.

At Step 1700, the line management system 100 may output the recommendations for each connection line 150. This output may take the form of a report to a system administrator including the recommendations, and/or may take the form of an output to a database where the recommendations for each connection line 150 are stored. This output may also include any explanation of the reason for the corresponding recommendation generated during Step 1650.

FIG. 2 shows a flowchart of how the line management system 100 may be implemented to assess whether an engineer callout is required for a suspected fault on a connection line 150.

Here, a consumer facing unit 200, or CFU, receives a report of a problem or issue on a broadband connection line 150. In some scenarios, the CFU 200 may be a system that is monitoring the connection line 150, may be a program (such as an app or website) for customers to report line issues, or may be a customer service agent receiving calls from customers relating to line issues.

Once the CFU 200 receives the report of a problem or issue on the broadband connection line 150, it then reports this to a next generation diagnostics, NGD, module 210 (which may be understood more generally to be a diagnostic module). The NGD module 210 then passes the details of the connection line 150 in question to the line management system 100 discussed above, which then runs the method of FIG. 1.

Here, the line management system 100 may form part of the NGD 210, or may be implemented separately to the NGD 210.

In addition, in some embodiments the method implemented by the line management system 100 may be run in parallel with other tools for diagnosing connection line 150 problems. This allows system administrators to assess the accuracy of the outputs of the line management system 100, or the accuracy of those other diagnostic tools if there is a sufficiently high level of confidence in the output of the line management system 100. In addition, the output of those other diagnostic tools may be used to further train the machine learning algorithm 160 of the line management system 100.

After the line management system 100 has run the method of FIG. 1 and produced the relevant recommendations for the connection line 150 in question, it produces an output to a reporting module 220. Here, the reporting module 220 receives the recommendations, as well as any plain English explanations of those recommendations, and outputs them to the CFU 200.

The reporting module 220, or the line management system 100, may also output the recommendations (and any plain English explanations of those recommendations) to a database 230 for storage.

The CFU 200 may then act upon the recommendations received from the reporting module 220. For example, the CFU 200 may arrange for an engineer to be sent out to assess the connection line 150, arrange for the further monitoring of the connection line 150, or arrange for an alternative action to be taken (for example, providing the customer with advice such as restarting a home router).

Therefore, the above process of FIG. 2 is an example of how the line management system 100 may be integrated into an existing NGD (or diagnostic) 210 framework. Here, the line management system 100 may be a separate module to the NGD (or diagnostic) module 210, and be able to run diagnostic tests across Home, FTTP, and Network areas.

The advantage of the above process of FIG. 2 is that instead of running individual tests for each separate area of a broadband network (i.e. Home, FTTP, and Network), the process can be run across all areas simultaneously.

The line management system 100 is also able to provide information as to where a potential fault is predominantly coming from (i.e. in the Network, Home, or FTTP).

This therefore saves time for the CFU 200. For example, where the CFU is a customer service agent, this reduces the time spent on a call to a customer.

In some embodiments, the CFU 200 customer service agent also has the ability to explain the reason as to why the customer is experiencing issues (i.e. where a plain English explanation is generated for each recommendation). In existing systems, if a test on a connection line 150 fails, very little feedback information is generated that can be given to a customer, often leading to an engineer being demanded which results in unnecessary engineer visits.

Therefore, knowing the key drivers of the problem allows service providers to give consumers greater confidence and awareness of any issues in the service on the connection line 150, such as those that cause intermittent or slow connections.

In addition, there is a benefit in terms of technology debt, namely the additional cost of maintaining or improving a service. That is to say, the process discussed above allows in the long-term for technology debt to be reduced, as the cost of maintaining separate diagnostic modules is reduced. The process discussed herein allows for potentially all diagnostics to be simplified into one module, and maintaining the streaming of data into a single module results in fewer potential bugs to the NGD/diagnostic platform as a whole.

Additional advantages are also provided for engineers assigned to visit a site to assess a connection line 150. For example, in scenarios where a clear fault is found by the line management system 100, the engineer can be provided with the most optimum recommended action(s) to perform to remedy the fault on site. This then avoids unnecessary actions, and reduces the time spent by an engineer on any given site.

Whilst the above discussed methods and systems are with regard to a broadband connection line, it will be appreciated that the same principles and approach may be applied to any suitable data network.

Any of the above discussed methods may be performed using a computer system or similar computational resource, or system comprising one or more processors and a non-transitory memory storing one or more programs configured to execute the method. Likewise, a non-transitory computer readable storage medium may store one or more programs that comprise instructions that, when executed, carry out the methods described herein.

Whilst certain embodiments have been described, these embodiments have been presented by way of example only, and are not intended to limit the scope of the application. Indeed, the novel devices, and methods described herein may be embodied in a variety of other forms; furthermore, various omissions, substitutions and changes in the form of the devices, methods and products described herein may be made without departing from the scope of the present application. The word “comprising” can mean “including” or “consisting of” and therefore does not exclude the presence of elements or steps other than those listed in any claim or the specification as a whole. The mere fact that certain measures are recited in mutually different dependent claims does not indicate that a combination of these measures cannot be used to advantage. The accompanying claims and their equivalents are intended to cover such forms or modifications as would fall within the scope of the application.

1. A method of diagnosing a potential fault on a broadband connection line, the method comprising:
receiving line data associated with a plurality of connection lines;
analysing, by a machine learning algorithm, the line data;
classifying, by the machine learning algorithm, the plurality of connection lines into a plurality of clusters based on the analysing of the line data;
wherein each of the plurality of clusters comprises a subset of the plurality of connection lines;
assigning, by the machine learning algorithm, a label to each cluster of the plurality of clusters, each label indicating the overall connection line performance of the connection lines in that cluster;
generating a metric score for each of a plurality of metrics associated with the performance of that connection line;
identifying, for each of the plurality of connection lines, deviating metric scores from among the generated metric scores for that connection line;
wherein a deviating metric score is a metric score indicates a potential fault on that connection line;
generating, for each identified deviating metric score, a recommendation based on one or more of:
the label of the cluster to which the connection line associated with that deviating metric score has been assigned;
the type of metric associated with that deviating metric score; or
the magnitude of the deviating metric score; and
outputting the generated recommendation for each connection line identified as having a deviating metric score.

2. The method according to claim 1, wherein the identifying of the deviating metric scores and the generating of the recommendation is carried out by a hypothesis testing algorithm.

3. The method according to claim 1, wherein the classifying by the machine learning algorithm includes employing a Gaussian mixture model.

4. The method according to claim 1, wherein the recommendation for each connection line identified as having a deviating metric score includes a recommendation regarding whether an engineer should be dispatched to investigate the connection line.

5. The method according to claim 1, wherein the recommendation for each connection line identified as having a deviating metric score includes a recommendation indicating the type of potential fault on that connection line.

6. The method according to claim 1, wherein the recommendation for each connection line identified as having a deviating metric score includes a recommendation indicating whether the potential fault on that connection line is located in one or more of:
the home network of the connection line;
the fibre to the property, FTTP, of the connection line; or
the network infrastructure of the connection line.

7. The method according to claim 1, wherein the recommendation for each connection line identified as having a deviating metric score includes a recommendation indicating a potential remedy of the potential fault on that connection line.

8. The method according to claim 1, wherein the method further comprises:
generating, by the machine learning algorithm, a plain English explanation for each generated recommendation; and
outputting the plain English explanation with the generated recommendation for each connection line identified as having a deviating metric score.

9. The method according to claim 1, wherein the method is implemented as a batch-processing method.

10. The method according to claim 1, wherein the method further comprises one or more of:
storing the received line data in a database; and
storing the generated recommendation for each connection line identified as having a deviating metric score in the database.

11. The method according to claim 1, wherein the method further comprises:
prior to classifying the plurality of connection lines into a plurality of clusters processing the line data, processing the line data such that the line data for each connection line is in the same format.

12. A system comprising:
one or more processors;
a non-transitory memory; and
one or more programs, wherein the one or more programs are stored in the non-transitory memory and configured to be executed by the one or more processors, the one or more programs including instructions for performing any of the methods of claim 1.

13. A non-transitory computer readable storage medium storing one or more programs, the one or more programs comprising instructions, which, when executed by an electronic device with one or more processors, cause the electronic device to perform any of the methods of claim 1.
